(19) United States
(12) Patent Application Publication
(10) Pub. No.: US 2024/0100516 A1
(43) Pub. Date: Mar. 28, 2024

(54) TEST CARTRIDGES AND SYSTEMS

(71) Applicant: Gerresheimer Regensburg GmbH, Regensburg (DE)

(72) Inventor: Nicholas Smartt, Muenster (DE)

(21) Appl. No.: 18/475,864

(22) Filed: Sep. 27, 2023

(30) Foreign Application Priority Data
Sep. 28, 2022 (EP) 22198539.3

(51) Int. Cl. B01L 3/00

(52) U.S. Cl. CPC B01L 3/502; B01L 2200/026; B01L 2300/042

(57) ABSTRACT

A test cartridge includes a body that defines a fluid path having a specimen inlet, a diluent inlet, a reagent inlet, a reaction chamber, and an air outlet. The test cartridge includes a cover to cooperate with the body to seal the fluid path, and a membrane coupled to the body. The membrane seals the diluent inlet, the reagent inlet, and the air outlet. The cover is transparent in the region of the reaction chamber.

### CROSS REFERENCE TO RELATED APPLICATIONS

This application claims priority to EP 2 219 8539.3, filed Sep. 28, 2022, the contents of which are incorporated herein in its entirety.

### TECHNICAL FIELD

This disclosure relates to test cartridges, such as for in vitro testing systems.

### BACKGROUND

In vitro diagnostic testing is typically performed in laboratory by trained technicians, where diluents and reagents are added to biological samples in open containers using hand pipettes inside a laminar flow cabinet. A laboratory includes controlled environmental conditions that can reduce risk of contamination. In vitro diagnostic tests detect the presence of biomarkers associated with a disease or medical condition in a biological sample taken from the patient. Sample types include blood, saliva, urine, soft tissue, and the like. The diagnostic test procedure generally involves mixing the biological sample with diluents and reagents, and detecting a result. The accuracy of the test result can depend on the accuracy of the liquid volumes of sample, reagents, and diluents that are added and mixed during the test, which presents challenges when titrating and mixing small and precise quantities of samples and liquids. Contamination from an outside environment or material carried over from prior tests in reused equipment can lead to unreliable test results, for example, if airborne bacteria or other foreign genetic material is accidentally mixed with a sample, reagents, or diluents.

### SUMMARY

This disclosure describes test cartridges for in vitro testing systems.

In a first aspect, a test cartridge comprises a body that defines a fluid path comprising a specimen inlet, a diluent inlet, a reagent inlet, a reaction chamber, and an air outlet, a cover configured to cooperate with the body to seal the fluid path, wherein the cover is transparent in the region of the reaction chamber, and a membrane coupled to the body and configured to seal the diluent inlet, the reagent inlet, and the air outlet.

In a second aspect according to the first aspect, the membrane comprises a plurality of discrete membrane portions, wherein each membrane portion is configured to seal one of the diluent inlet, the reagent inlet, or the air outlet.

In a third aspect according to the second aspect, the test cartridge further comprises a plurality of membrane clamps, wherein each membrane clamp is configured to clamp a respective membrane portion to the body.

In a fourth aspect according to any one of the first aspect to the third aspect, the body has one or more surfaces, and the diluent inlet, the reagent inlet, and the air outlet are arranged on the same surface of the one or more surfaces of the body.

In a fifth aspect according to any one of the first aspect to the fourth aspect, the body further defines a threaded connection adjacent to the specimen inlet.

In a sixth aspect according to any one of the first aspect to the fifth aspect, the test cartridge further comprises a protective film configured to seal the specimen inlet.

In a seventh aspect according to any one of the first aspect to the sixth aspect, the reaction chamber is a first reaction chamber, and the fluid path comprises a second reaction chamber in serial arrangement relative to the first reaction chamber.

In an eighth aspect according to any one of the first aspect to the seventh aspect, the cover is transparent in the region of the specimen inlet, the diluent inlet, the reagent inlet, the one or more reaction chambers, and the air outlet.

In a ninth aspect according to any one of the first aspect to the eighth aspect, the body is monolithic.

In a tenth aspect according to any one of the first aspect to the ninth aspect, the fluid path further comprises a wash chamber.

In an eleventh aspect, a test assembly comprises the test cartridge according to any one of the first aspect to the tenth aspect, and a fluid connector comprising a carrier plate that defines a plurality of openings, wherein each opening is configured for alignment with one of the diluent inlet, the reagent inlet, or the air outlet, a plurality of hypodermic needles, wherein each hypodermic needle is arranged at a corresponding opening of the carrier plate, and a plurality of needle tubes, wherein each needle tube is coupled to the hypodermic needle.

In a twelfth aspect according to the eleventh aspect, the test assembly further comprises a plurality of pumps, each pump having a pump inlet and a pump outlet, wherein each pump outlet is configured for connection to one of the plurality of needle tubes.

In a thirteenth aspect according to the twelfth aspect, the test assembly further comprises, for each of the plurality of pumps, a container that comprises a container wall defining an interior space configured to receive a liquid, wherein each pump is connected to the container wall with the pump inlet in direct communication with the interior space of the container.

In a fourteenth aspect, a test system comprises a test assembly according to the twelfth aspect or the thirteenth aspect, a plurality of pump drives, wherein each pump drive is configured to drive a respective one of the plurality of pumps, and a cartridge holder configured to receive the test cartridge, wherein the test system is configured to move the fluid connector towards the body of the test cartridge, such that each of the plurality of hypodermic needles pierces the membrane of the test cartridge and fluidly couples a respective needle tube to one of the diluent inlet, the reagent inlet, or the air outlet.

In a fifteenth aspect according to the fourteenth aspect, the cartridge holder is configured to support the test cartridge such that the fluid path extends in a substantially vertical direction.

In a sixteenth aspect according to the fourteenth aspect or the fifteenth aspect, the test system is further configured to pivot the carrier plate relative to the test cartridge to move the fluid connector towards the body of the test cartridge.

In a seventeenth aspect according to any one of the fourteenth aspect to the sixteenth aspect, each of the plurality of pump drives comprises a 5-phase stepper motor configured to drive a respective one of the pumps.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a perspective front view of an example test cartridge.

FIG. 2 is a perspective back view of the example test cartridge of FIG. 1.

FIG. 3 is an exploded perspective front view of the example test cartridge of FIG. 1.

FIG. 4 is a partially exploded perspective back view of the example test cartridge of FIG. 1.

FIG. 5 is a perspective view of an example test assembly including a fluid connector and a test cartridge.

FIG. 6 is a cross-sectional side view of a portion of the example test assembly of FIG. 5.

FIG. 7 is a perspective view of an example test system.

FIG. 8 is a cross-sectional perspective view of the example test system of FIG. 7.

FIG. 9 is a partial perspective front view of a part of the example test system of FIG. 7.

FIG. 10 is a cross-sectional, partial perspective back view of the part of the example test system of FIG. 9.

FIG. 11 is a partial perspective back view of the part of the example test system of FIG. 9.

FIG. 12 is a partial perspective back view of the part of the example test system of FIG. 9.

FIG. 13 is a perspective view of an example pump drive.

Like reference numbers and designations in the various drawings indicate like elements.

### DETAILED DESCRIPTION

This disclosure regards test cartridges for in vitro test systems. A test cartridge includes a membrane for preventing contamination and controlling an inflow of fluid, such as a diluent, reagent, both, or other fluids for a diagnostic test. The membrane prevents or reduces contamination, and in some instances, the test cartridge excludes pre-stored fluids (or other substances) within the test cartridge itself prior to a testing operation. Instead, the membrane of the test cartridge allows for the pumping of fluids (e.g., diluents and reagents) and/or other substances into the test cartridge in a controlled environment through a pierceable septum membrane for non-contaminated fluid transfer between a source container of the fluids to the reaction chamber of the test cartridge. The test cartridge includes a body defining a fluid path having a specimen inlet, a diluent inlet, a reagent inlet, a reaction chamber, and an air outlet. A cover corresponding with the body cooperatively seals the fluid path of the body. The test cartridge includes the membrane, which is coupled to the body and seals the diluent inlet, the reagent inlet, the air outlet, a combination of these, or all of these inlets. The specimen inlet accepts a biological sample, such as on a swab or as a bodily fluid sample, and the membrane includes a pierceable septum for introduction of fluids into the cartridge through inlets, such as the diluent and reagent through the diluent inlet and reagent inlet. The test cartridge is disposable, such as at an end of a testing sequence after the biological sample is received, diluent and reagent is received, and the sample is tested.

In some instances, one or more fluids are introduced into a reaction chamber of the cartridge through the inlet ports that are sealed with the membrane. Each of the ports can be sealed with a discrete portion of the membrane, such as pierceable septum membrane portions made out of thermoplastic elastomer, silicone, a combination of these materials, or other materials. In some example testing operations, a sharp hypodermic needle pierces the membrane, allowing a fluid to be pumped into or out of the reaction chamber of the cartridge through a respective inlet port, while protecting the inside of the cartridge from contamination. The hypodermic needle(s), tubing, and pump(s) for each respective inlet port can all be disposable. In some implementations, such as during a change over to a different type of test or after a predetermined number of tests, the needle(s), tubing, and pump(s) can be replaced. In certain implementations, a separate air outlet, having a similar design as the inlet ports, can be provided to allow air to be vented out of the cartridge as liquids or other substances are pumped in through the inlet ports. Tubing connected to the inlet ports can include a valve connected to positive or negative pressure, such that an air pressure could be used to transfer liquids through the tubing of the testing assembly.

Each of the reagents or diluents has its own pump and respective inlet port to transfer liquids into the cartridge. Liquid reagents, diluents, or both, are not stored within the cartridge, and instead can be stored in multi-use disposable containers. Each of the multi-use disposable containers can hold sufficient liquid for multiple tests, for example, 20 tests, 100 tests, 1000 tests, or more tests. Each pump can be an integral part of its respective container, or can be mounted as a stand-alone unit between the containers and the cartridge.

In traditional laboratory tests, diluents and reagents are added to a biological sample in open containers using a hand pipette inside a laminar flow cabinet. Calibrated hand pipettes require highly trained personnel and controlled laboratory conditions to achieve accurate results. Molecular laboratory tests can synthesise more than 10 million copies of a particular RNA or DNA fragment. If foreign DNA or DNA fragments from previous test samples are present in the sample, even in miniscule quantities, this can be copied and amplified, leading to incorrect results. It is important in laboratory tests to avoid contamination of labware and carry-over of sample material from one test to the next. Even with the pipetting process being automated using pipetting robots programmed to pipette liquid between open containers, contamination can occur and tests generally are carried out in a laboratory to prevent contamination of test samples. Further, many common pipetting robots are physically large, complex and expensive. In the present disclosure, disposable test cartridges with an integral membrane allows for the introduction of fluids (such as diluents or reagents) into a sealed container with a specimen to be tested, and reduced risk of contamination because of the seal from the membrane disposed between a reaction chamber and the source of introduced fluids. In some implementations, miniaturized, disposable, injection moulded cartridges provide a fast, convenient, and cost-effective way to carry out diagnostic tests without needing laboratory conditions. Small volumes of biological samples can be mixed with reagents and/or other substances within the cartridge, producing a measurable signal that indicates the presence or concentration of a biomarker. The cartridge is generally sealed to prevent contamination from an outside environment, and is discarded after a single use, for example, to prevent carry-over of samples between tests.

In disposable cartridges, a biological sample is introduced into the cartridge, which is then closed and sealed. In certain implementations, reagents and other fluids are stored in the test cartridge itself in liquid form or in freeze-dried pellet form, and are then added to the sample within the cartridge. In the case of pellet form reagents, the pellets are reconstituted with water immediately prior to a testing sequence. This construction of reagents pre-stored within the cartridge can reduce the risk of contamination compared to pipetting liquids between open containers. However, if liquids or pellets are stored inside the cartridge, the cartridge must be filled and sealed as part of the manufacturing process of the cartridge, which is time-consuming and expensive, especially so when requirements for volume accuracy are high. Further, if the cartridge also contains water or aqueous buffers to reconstitute the pellets, this liquid can migrate through the internal walls of the cartridge during storage. To prevent internal moisture transfer, the cartridge is constructed with thick internal walls and/or using expensive materials with high moisture barrier properties, and the cartridge itself may need to be refrigerated until a point of use, which creates logistical problems and potential quality issues. In the present disclosure, fluids, such as reagents, diluents, or other fluids do not need to be stored within the cartridge prior to testing, but instead are pumped into the cartridge through the membrane, such as through dedicated inlet ports per fluid with separate membrane portions, where the membrane can be pierced to allow introduction of the fluids while reducing or preventing contamination.

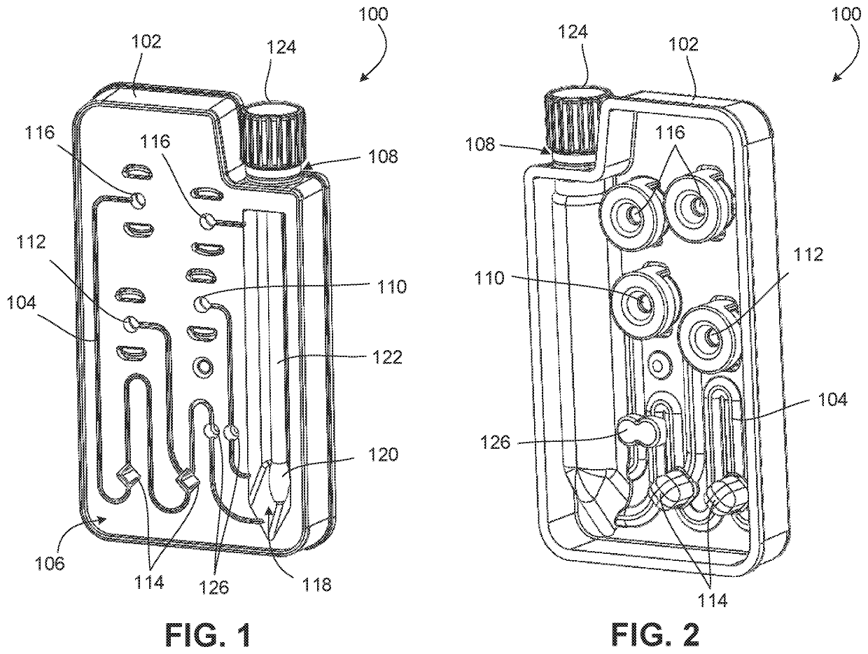

FIG. 1 is a perspective front view of an example test cartridge 100, and FIG. 2 is a perspective back view of the example test cartridge 100. The example test cartridge 100 includes a body 102 that defines a fluid path 104 on or within a front surface 106 of the body 102. In some implementations, the fluid path 104 includes a recessed channel on the front surface 106 of the body 102, or a partially or completely enclosed fluid channel along or behind the front surface 106 of the body 102. For example, in the example test cartridge 100 of FIGS. 1 and 2, the fluid path 104 includes tubular flow channels coupled to or integrated with the body 102, where a portion of the flow channels are open in the front surface 106 of the body 102, in that an interior of the flow channels of the fluid path 104 are partially opened to and visible through the front surface 106 of the body 102. The body 102 of the example test cartridge 100 can be molded plastic, such as injection molded plastic, and the material of the body 102 is fluid impervious. In some instances, the body 102 is monolithic, such as formed from a single piece of injection molded plastic.

The fluid path 104 of the example test cartridge 100 includes a specimen inlet 108, a diluent inlet 110, a reagent inlet 112, a reaction chamber 114 (two shown), and an air outlet 116 (two shown). The fluid path 104 is a meandering path on the front surface 106 of the body 102, with the specimen inlet 108, diluent inlet 110, reagent inlet 112, reaction chamber 114 (two shown), and air outlet 116 spaced separately from each other along the meandering fluid path 104. The fluid path 104 directs, flows, transfers, or otherwise moves fluid along channels of the fluid path 104 to promote a mixing or other movement of liquids and/or other substances along the fluid path 104. In the illustrated fluid path 104 of the example test cartridge 100 if FIGS. 1 and 2, the channel of the fluid path 104 transfers fluid from one of the reaction chambers 114 to the next. The fluid path 104 does not need to provide a mixing function, as mixing can have already taken place in the reaction chamber 114. In some implementations, other fluids can be introduced into the example test cartridge 100 simultaneously through multiple inlets, each with an associated flow channel in the fluid path 104. The flow channels of the fluid path 104 can include different liquids and are arranged to join together and flow through a single channel of the flow path 104, for example, toward one or both of the reaction chambers 114. As different liquids flow alongside each other in a single channel portion of the for path 104, the different liquids are gradually mixed, such as by diffusion since there may be little to no turbulent flow to aid in mixing at a small scale of test cartridges. In some examples, a flow channel of the fluid path 104 that has a relatively long mixing length can be fitted into a small area on the example test cartridge 100 by arranging it to double back on itself in a meandering shape. This allows fluids to be mixed on the cartridge without needing a separate reaction chamber.

The diluent inlet 110, reagent inlet 112, and air outlet 116 are arranged on the same surface (e.g., the front surface 106) of the body 102. In some instances, the diluent inlet 110, reagent inlet 112, air outlet 116, reaction chamber 114, or a combination of these are labeled on the front surface 106 of the body 102, for example, to more readily view these respective elements on the body 102, such as in instances where these elements appear similar in shape or design on the front surface 106 of the body 102. Placing the diluent inlet 110 and reagent inlet 112 on the same surface of the body 102 provides for convenient arrangement of the sources of a diluent and a reagent. However, these inlets can be arranged on the body 102 in a different arrangement, such as on other surfaces of the body 102 or on different surfaces of the body 102.

The fluid path 104 can include additional or different features. For example, the fluid path 104 of the example test cartridge 100 includes a wash chamber 118 fluidly connected to the specimen inlet 108 between the specimen inlet 108 and the reaction chamber 114. The wash chamber 118 acts as a holding chamber for holding a specimen that enters through the specimen inlet 108. In some embodiments, a testing specimen is introduced through the specimen inlet 108 in the form of a swab (such as swab tip 120 of FIG. 1), or the testing specimen is otherwise introduced to the wash chamber 118 via the specimen inlet 108. In the example test cartridge 100 of FIG. 1, the specimen is disposed on a swab tip 120 suspended in the wash chamber 118 on a swab rod 122 extending from a base structure to the swab tip 120. In some embodiments, the base structure of the swab acts as a screw cap 124, in that the swab rod 122 is coupled to (for example, directly connected to or integral with) the screw cap 124. The screw cap 124 seals the specimen inlet 108, for example, with a sealing connection. The sealing connection creates a hermetic seal at the specimen inlet 108. The sealing connection can take the form of threading, such as threading on the specimen inlet 108 that sealingly engages with corresponding threading of the screw cap 124. For example, the body 102 can define a threaded connection adjacent to the specimen inlet 108 to engage and seal to corresponding threads on the screw cap 124. However, other sealing connections exist, such as snap-on caps that engage corresponding a lip edge of a specimen inlet. In some implementations, the example test cartridge 100 includes a protective film (not shown) over the specimen inlet 108, for example, to seal the specimen inlet 108 in order to keep the fluid path 104 sterile prior to insertion of the swap tip 120.

In some implementations, the wash chamber 118 holds a liquid that is mixed with a biological material delivered on the swab tip 120. For example, liquid diluent (such as dilution buffer with a controlled pH) can be pumped from a separate storage reservoir outside the example cartridge 100 into the wash chamber 118. An external pump system can be programmed to hold the liquid in the wash chamber 118 for a predetermined period of time (for example, a few seconds), submerging the end of a swab tip 120 to promote the transfer of biological material from the swab tip 120 into the liquid. In some instances, the liquid can be agitated to improve the efficiency of sample removal from the swab tip 120, for example by pumping air or liquid into the wash chamber 118 so that air bubbles or jets of fast moving liquid impact the tip 120 of the swab. After a pre-programmed time interval, an external pump can create a pressure differential to transfer the diluent liquid together with the sample material into a further chamber along the fluid path 104.

The fluid path 104 of the example test cartridge 100 also includes two reaction chambers 114 in series with each other along the fluid path 104. The two reaction chambers 114 are used to separate the particular molecules of interest from the rest of the material present in the biological sample, making the biological material available for detection and removing material that could interfere with the detection process. The biological material to be detected could include antigens, antibodies, or specific DNA or RNA sequences. In some instances, biological cell walls may need to be broken open (cell lysis), for example, by adding organic solvents, chelating agents, detergents or surfactants. Alternatively, the cell walls can be broken open using ultrasound or temperature treatments. Embodiments of the present disclosure allow for different lysis methods to be employed. For example, multiple reaction chambers (such as the two reaction chamber 114 of the example test cartridge 100) can be used to successively clean the sample, separating the biological material of interest from impurities, cell debris, and/or other extraneous material that may be present on the swab tip 120. In some implementations, sample purification can be achieved with filtration, solvent extraction, or coated magnetic beads, thereby separating the biomolecules of interest from the rest of the sample. Multiple reaction chambers 114 allow multiple purification steps to be carried out sequentially, achieving high levels of sample purity and potentially increasing the sensitivity and selectivity of the test result. However, in some instances, the fluid path 104 may include only one reaction chamber 114, or more than two reaction chambers 114 along the fluid path 104.

The fluid path 104 of the example test cartridge 100 also includes two air outlets 116, or vents. The air outlets 116 are disposed at opposite ends of the fluid path 104, for example, to vent air or other gas out of the fluid path 104 before, during, or after a specimen testing sequence involving the introduction of fluids or other substances into the fluid path 104. The air outlets 116 of the example test cartridge 100 include a first air outlet proximate to the specimen inlet 108, such as at the wash chamber 118, and the second air outlet is on an opposite end of the fluid path 104, opposite to the specimen inlet 108. The air outlets 116 prevent leakage of biological material during and after use, and are normally sealed except, for example, when punctured. Though the air outlets 116 are described herein as outlets for air flow, the air outlets also function as inlets for air flow such as from an external air pump. For example, external air pumps together with external air valves can be configured to provide precise control of the air pressure within different regions of the channels of the fluid path 104 via air flow control at the air outlets 116, such as by creating a pressure differential to drive the flow of liquids through the fluid path 104 of the example test cartridge 100. In some implementations, the first air outlet is provided in the wash chamber 118 to allow air to be removed and pressure equalized during an initial stage of washing the swab tip 120, without driving fluid through the fluid path 104 of the example test cartridge 100.

The air pressure in the fluid path 104 can be controlled at the air outlets 116 to manage air bubbles within the channels of the fluid path 104. Air bubbles may be undesirable because they can interfere with optical or electrical measurements. The overall air pressure in the fluid path 104 of the example test cartridge 100 can be increased, for example, to reduce the size of any air bubbles in the liquid disposed in the fluid path 104 and/or wash chamber 118. Alternatively the pressure in the fluid path 104 and/or wash chamber 118 can be reduced, so that any bubbles near free surfaces in the test cartridge 100 are expanded until the surface tension holding the bubble together is broken and the bubbles burst at the surface and release the trapped air. In some instances, the fluid path 104 may include only one air outlet 116, or more than two air outlets 116 along the fluid path 104.

In some implementations, the fluid path 104 includes a capillary trap 126 that reduces or prevents a flow of liquid by capillary action through the channels of the fluid path 104 when there is no active pumping of liquids through the fluid path 104. The capillary trap 126 is positioned between the diluent inlet 110 and the wash chamber 118 to prevent or reduce a backwards flow of liquid including the biological sample toward the diluent inlet 110 after liquid has finished being pumped into the wash chamber 118. The capillary trap 126 prevents liquid flow backwards by capillary action towards the inlet 110, which could potentially contaminate the inlet septum and cannula at the diluent inlet 110. The capillary trap 126 reduces the risk of cross-contamination from one test cartridge to the next. The capillary trap 126 is also positioned between the wash chamber 118 and the first reaction chamber 114, for example, to prevent premature flow into the reaction chamber 114 before the sample is properly washed off of the swab tip 120 in the wash chamber 118.

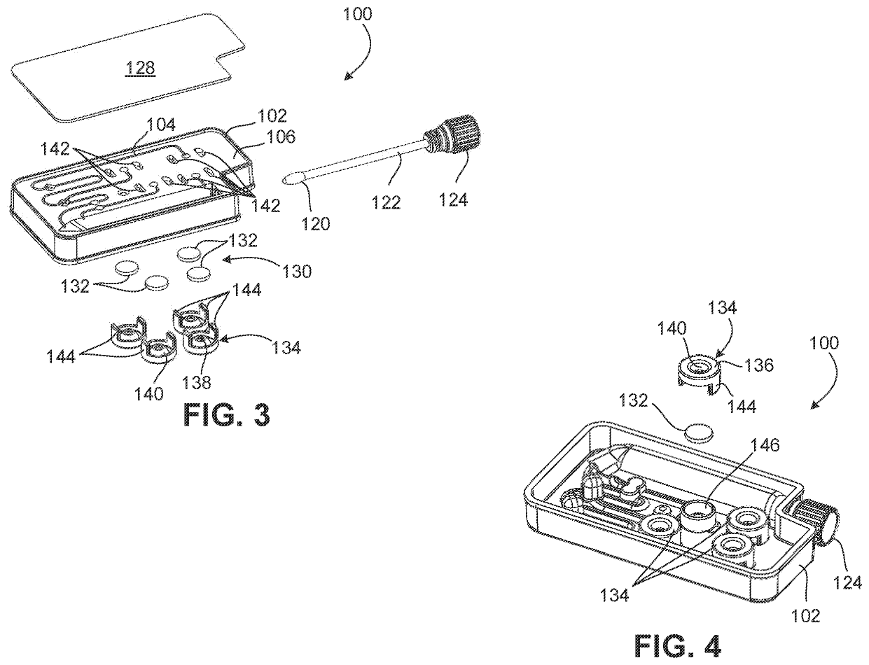

FIG. 3 is an exploded perspective front view of the example test cartridge 100, and FIG. 4 is a partially exploded perspective back view of the example test cartridge 100 of FIG. 1. The example test cartridge 100 includes a cover 128 disposed over the front surface 106 of the body 102, and cooperates with the body 102 to seal the fluid path 104. For example, the cover 128 closes the open portion(s) of the fluid path 104 at the front surface 106 of the body 102. In some implementations, the fluid path 104 is enclosed within the body 102, in that there are fewer or no open portions of the fluid path 104 in the front surface 106 of the body. In some examples, the front surface 106 is transparent (partially or completely) in order to view an interior of the fluid path 104. In certain implementations, the cover 128 is transparent (partially or completely) at least in the region of the reaction chamber 114. For example, the cover 128 can be transparent in the area of the reaction chamber(s) 114, diluent inlet 110, reagent inlet 112, air outlet(s) 116, wash chamber 118, a combination of these, all of these, or other areas on the cover 128. In certain examples, the cover 128 is transparent only in the region of the reaction chamber 114, whereas some examples include the cover 128 being transparent in more regions than just the reaction chamber 114. The transparency of the cover 128 allows a viewer to visibly track a progress or flow of liquids along portions of the fluid path 104, and in some implementations, control an introductory flow of reagent and/or diluent and/or control a venting through the air outlet(s) 116. The transparent cover 128 can be fixed to the body 102 using pressure sensitive adhesive, can be laser-welded, or fixed using other methods. In some implementations, a strong laser welded joint is easier to achieve if one part is transparent (such that it does not absorb laser light) and the other part opaque (such that it absorbs laser light). For example, if an assay running in the example test cartridge 100 includes optical detection, such as by detecting a color change or a change in fluorescence from a fluorophore label, an optical transparent window provided by the transparent cover 128 allows for detection through the transparent cover 128 of the example test cartridge 100. The cover 128 can be formed of a variety of materials, such as glass, vinyl, plastic, or other transparent and rigid materials.

The example test cartridge 100 includes a membrane 130 coupled to the body 102 to selectively seal the diluent inlet 110, the reagent inlet 112, and the air outlet 116. The membrane 130 seals to the body on a back side of the body 102 opposite to the cover 128. The membrane 130 selectively seals the diluent inlet 110, reagent inlet 112, and air outlet(s) 116 in that the membrane 130 provides a hermetic seal to these respective inlets and outlets of the fluid path 104, but the membrane 130 can be pierceable by a needle or other injection structure that engages with one or more of the diluent inlet 110, reagent inlet 112, or air outlet(s) 116 of the fluid path 104. In the example test cartridge 100 as shown in FIGS. 3 and 4, the membrane 130 takes the form of separate, discrete membrane portions 132 (four shown). The four membrane portions 132 align with the diluent inlet 110, reagent inlet 112, and two air outlets 116, in that each membrane portion 132 seals one of the diluent inlet 110, the reagent inlet 112, or one of the air outlets 116.

The example test cartridge 100 of FIG. 3 shows the membrane 130 in the form of discrete membrane portions 132. However, in some implementations, the membrane 130 includes a single sheet of material that seals all or a subset of the diluent inlet 110, reagent inlet 112, and air outlets 116. For example, a single layer of the membrane can cover the diluent inlet and the reagent inlet, and one or both of the air outlets 116 can be sealed with the same single layer or a different layer of the membrane.

The membrane 130 forms one or more pierceable septums over the diluent inlet 110, reagent inlet 112, and air outlet(s) 116. For example, each membrane portion 132 can include a circular layer of thermoplastic elastomer (TPE) that acts as a septum, for example, for piercing by a needle. The membrane 130 is pierceable, such as by a needle, and continues to seal even after the needle is removed from the membrane 130. The material of the membrane 130 can vary. For example, the membrane 130 can include a TPE, silicone, other elastomers, or other suitable soft material for sealing the inlets and/or outlets.

In the example test cartridge 100 of FIGS. 3 and 4, the membrane portions 132 take the form of circular discs that can match the corresponding inlet or outlet of the fluid path 104 on the body 102. The membrane portions 132 are clamped to respective portions of the body 102, in particular, covering the corresponding part of the body 102. For example, a first of the membrane portions 132 covers the diluent inlet 110, a second of the membrane portions 132 covers the reagent inlet 112, a third of the membrane portions 132 covers a first of the air outlets 116, and a fourth of the membrane portions 132 covers a second of the air outlets 116. The membrane portions 132 are individually clamped to the body 102 with respective membrane clamps 134. Each membrane clamp 134 clamps a respective membrane portion 132 to the body 102. For example, a first of the membrane clamps 134 clamps the first of the membrane portions 132 over the diluent inlet 110, a second of the membrane clamps 134 clamps the second of the membrane portions 132 over the reagent inlet 112, a third of the membrane clamps 134 clamps the third of the membrane portions 132 over the first of the air outlets 116, and a fourth of the membrane clamps 134 clamps the fourth of the membrane portions 132 over the second of the air outlets 116. The number of membrane portions 132, membrane clamps 134, or both, can vary based on the number of inlets or outlets intended to be sealed with the membrane 130. For example, the number of membrane portions 132, membrane claims 134, or both, can be less than four (e.g., three membrane portions 132 and three membrane clamps 134), or more than four (such as five membrane portions 132 and five membrane clamps 134).

The membrane clamps 134 can take a variety of forms to secure the membrane portions 132 to the body 102 and create a hermetic seal over the respective inlet or outlet in the body 102. In the example test cartridge 100 of FIGS. 3 and 4, each membrane clamp 134 includes a circular body 136 with a central opening 138 in a middle of the circular body 136. The central opening 138 allows for passage of a needle through the central opening 138 and subsequently through the membrane portion 132. In some instances, the circular body 136 includes an inwardly-directed conical taper 140 along a perimeter of the central opening 138, where the conical taper 140 forms a progressively narrower opening from a first end of the conical taper 140 to a second, opposite end of the conical taper 140. The second end the conical taper 140 is a recessed edge that forms the central opening 138. The conical taper 140 of the circular body 136 of the membrane clamp 134 acts as a guiding surface, for example, to guide a needle toward and through the corresponding membrane portion 132. In some instances, the second end of the conical taper 140 acts as a sealing edge that approaches a wall of the body 102, for example, to compress a perimeter of the membrane portion 132 against the portion of the body 102 and create a compression seal around the respective inlet or outlet of the fluid path 104. The second end of the conical taper 140 of the membrane clamp 134, when the membrane clamp is locked in a sealed position, compresses the perimeter of the membrane portion 132 against the portion of the body 102 to effect a seal at the respective inlet or outlet of the fluid path 104 on the back side of the body 102.

In order to lock the membrane clamp 134 in the sealed position, each membrane clamp 134 includes a locking structure that engages with and locks to a corresponding structure on the body 102. For example, the example test cartridge 100 of FIGS. 1 to 4 include openings 142 through the front surface 106 of the body 102 that engage with one or more lock arms 144 (two shown per membrane clamp 134) that are connected to the circular body 136 of each membrane clamp 134. The lock arms 144 can include a detent structure that catch an edge of the front surface 106 of the body surrounding one or more of the openings 142 to lock a respective membrane clamp 134 in its sealed position, as shown in the example test cartridge 100 of FIGS. 2 and 4.

In some instances, such as in the example test cartridge 100 of FIG. 4, the body 102 includes a cylindrical protrusion 146 (four total, one shown) around each of the diluent inlet 110, reagent inlet 112, and air outlets 116. The cylindrical protrusions 146 extend rearwardly from a planar surface of the body 102 at the back of the body 102 (for example, opposite from the front surface 106). The cylindrical protrusions 146 support the membrane clamps 134 in the sealed position on the body 102. For example, the circular body 136 of the membrane clamps 134 contact and reside on respective cylindrical protrusions 146, such that the cylindrical protrusions 146 position the membrane clamps 134 on the body 102. As the membrane clamps 134 are positioned on the body 102 and engage the cylindrical protrusions 146 and the openings 142, the cylindrical protrusions 146 and the detent structures lock the membrane clamps 134 in place on the body 102.

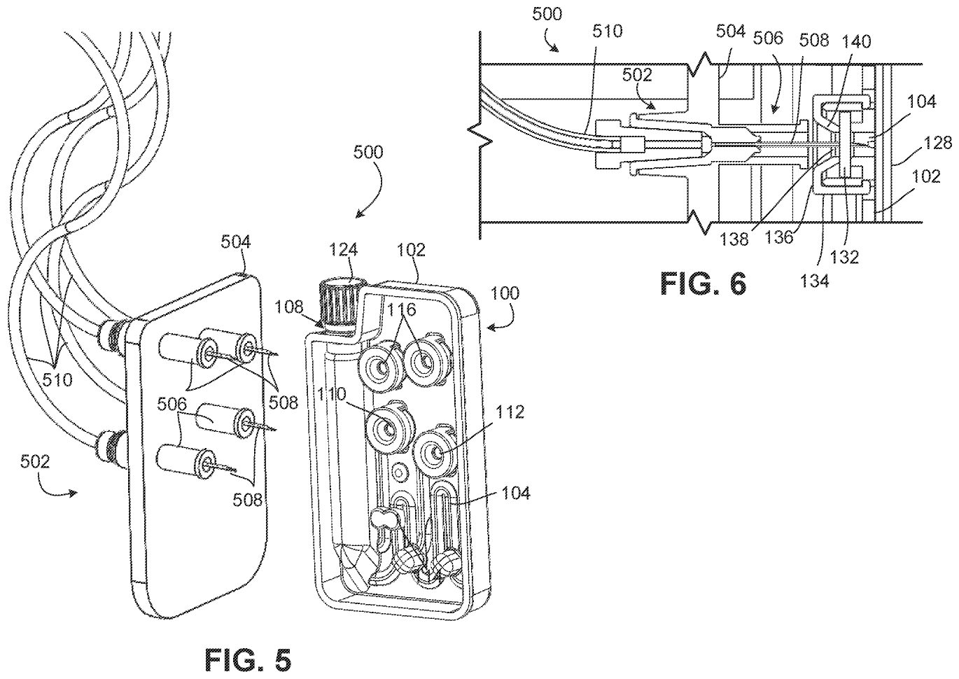

The example test cartridge 100 is disposable, and can be used in a testing assembly with a corresponding set of hypodermic needles and respective fluid pumps for feeding a reagent and diluent to the test cartridge 100, and in some instances, venting air out of the fluid path of the test cartridge 100. FIG. 5 is a perspective view of an example test assembly 500 including a fluid connector 502 and the example test cartridge 100 of FIGS. 1-4. The fluid connector 502 of the example test assembly 500 includes a carrier plate 504 with a plurality of openings, each opening supporting a needle assembly 506. The carrier plate 504 has a planar shape to match the corresponding shape of the test cartridge 100, however, the shape of the carrier plate 504 can vary, such as to match a corresponding shape of the test cartridge. Each opening and respective needle assembly 506 on the carrier plate 504 aligns with one of the diluent inlet 110, the reagent inlet 112, or the air outlet 116. Each needle assembly 506 includes a hypodermic needle 508 corresponding to one of the diluent inlet 110, reagent inlet 112, or one of the air outlets 116 of the example test cartridge 100, and each needle 508 is coupled to and fluidly connected to a dedicated needle tubing 510 extending from a back side of the carrier plate 504 opposite to the hypodermic needle 508. Each of the dedicated needle tubing 510 connect to a fluid source, gas tank, pump, a combination of these, or another type of enclosed container that directs and controls a movement of fluid through the tubing 510 and through its corresponding hypodermic needle 508. Each hypodermic needle 508 is arranged at a corresponding opening of the carrier plate 504 so that the hypodermic needles 508 are aligned with the diluent inlet 110, the reagent inlet 112, and the air outlet 116.

FIG. 6 is a cross-sectional side view of a portion of the example test assembly 500 of FIG. 5 in an engaged position, where one of the needle assemblies 506 is engaged with one of the inlets of the example test cartridge 100. As depicted in FIG. 6, the carrier plate 504 is moved into close proximity with or into contact with the body 102 of the test cartridge 100 such that the hypodermic needle 508 penetrates the membrane portion 132 secured to the body 102 with the membrane clamp 134, and distal end of the hypodermic needle 508 is disposed within a flow channel of the fluid path 104. Referring to FIGS. 5 and 6, the example test assembly 500 can include multiple pumps (not shown), where each pump has a pump inlet and a pump outlet, and each pump outlet connects to one of the needle tubes 510. The pumps are described in greater detail below. In a testing operation, a pump connected to the flexible needle tube 510 can pump a liquid (for example, reagent, or diluent) into the fluid path 104 and/or pump a gas (for example, air) into or out of the fluid path 104 through the distal end of the hypodermic needle 508.

In some implementations, the needle tubing 510 corresponding to the air outlets 116 include air outlet tubing that connects to a valve, which can either allow air flow out of the air outlet 116 of the example test cartridge 100 and enable liquid movement within the cartridge, or allow pressure to increase inside the cartridge as inlet fluid pumps drive fluid into the example test cartridge 100. The tubing at the air outlet 116 can also be connected to an external pump generating an under-pressure at the outlet side of one or both of the air outlets 116, effectively sucking liquid through the fluid path 104 of the example test cartridge 100. In some examples, a filter can be placed in the outlet tubing as a safeguard against biological material escaping from the assembly 500.

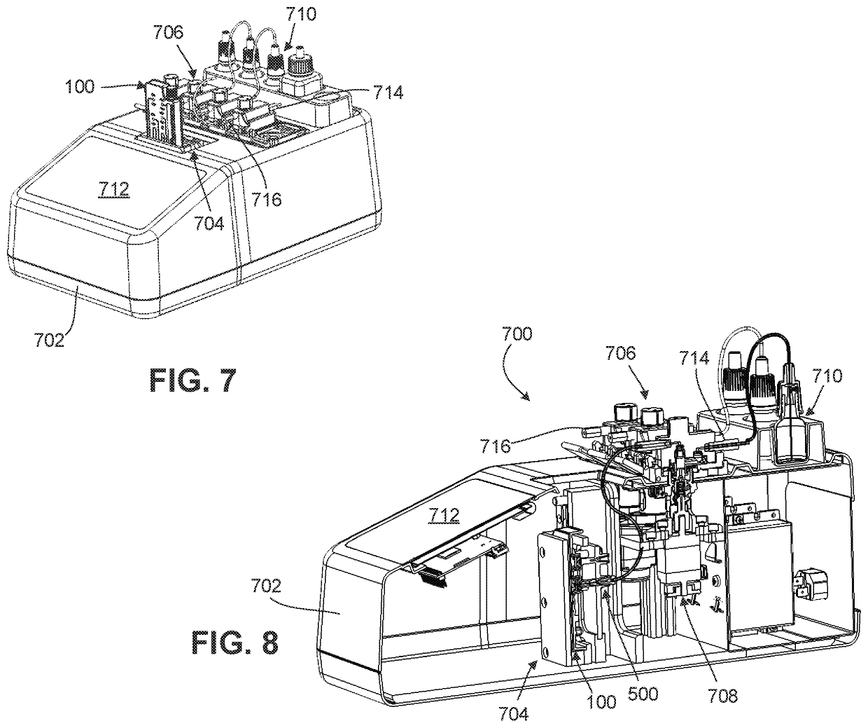

The example test assembly 500 can be used in a dedicated test system that includes a base structure that supports the example test cartridge 100, supports the example fluid connector 502, and connects the fluid connector 502 to respective pumps, fluid sources, or other components of a complete test system. For example, FIG. 7 is a perspective view of an example test system 700, and FIG. 8 is a cross-sectional perspective view of the example test system 700 of FIG. 7, which includes the example test assembly 500 and the example test cartridge 100. The test system 700 includes a base structure 702 including a cartridge holder 704 that supports the example test cartridge 100 of FIGS. 1-6 and the example test assembly 500 of FIGS. 5-6 within or on the base structure. The base structure 702 includes a housing or frame that supports the cartridge holder 704 and other components of the test assembly 500, including pumps 706, pump drives 708, fluid containers 710, and in some instances, a user interface 712. The user interface 712 can include a screen display, for example, to show a testing operation status, initiate a testing operation, control a testing operation, or otherwise display information relevant to the test system 700. The screen can include a touchscreen, and in some instances, can include buttons or other user-manipulated controls.

The fluid containers 710 hold fluids that are introduced to the test cartridge 100 in a controlled manner, or in some instances, removed from the test cartridge 100 in a controlled manner. For example, the fluid containers 710 can hold one or more reagents, one or more diluents, or other fluids. All or a subset of the fluid containers 710 are fluidly connected to the pumps 706 for controlled injection of a fluid or multiple fluids into the test cartridge 100 through the needle tubes 510 and fluid connector 502.

Each of the needle tubes 510 connect one end to its respective hypodermic needle 508, and on its second, opposite end to one of the pumps 706, to an air tank, or to a different component of the test system 700. Each of the pump drives 708 drives a respective one of the pumps 706. Each of the pumps 706 also fluidly connect to one (or more) of the fluid containers 710, for example, to pump a fluid (for example, a diluent or reagent) from one or more of the fluid containers 710 through one or more of the needle tubes 510 and out of the respective hypodermic needles 508. The example test system 700 of FIGS. 7 and 8 include four fluid containers 710, two of which are connected with tubing to two pumps 706, and two pump drives 708 drive the two pumps 706 to pump fluid (such as the diluent and reagent) along the needle tubing 510 to the respective hypodermic needles 508 that are fluidly connected to the test cartridge 100. The number of fluid containers 710, pumps 706, needle tubes 510, and hypodermic needles 508 can vary, for example, based on a number of fluids that are to be introduced to the test cartridge 100.

Each of the pumps 706 have a pump inlet 714 and a pump outlet 716, and each pump outlet 716 connects to one of the needle tubes 510. In some implementations, each fluid container 710 includes a container wall defining an interior space configured to receive a liquid. The pump 706 can be fluidly connected to the container wall with the pump inlet 714 in direct communication with the interior space of the fluid container 710, for example, via a tubing that extends directly between the pump inlet 714 and the interior space of the fluid container 710.

The test system 700 can include a controller (not shown) communicably connected to the components of the test system 700, such as the user interface 712, pumps 706, and pump drives 708, for example, to control, monitor, and display a testing operation of a test cartridge.

The cartridge holder 704 positions the cartridge 100 in the test system 700, and the test system 700 guides the fluid connector 502 into proper engagement with the test cartridge 100. For example, the cartridge holder 704 receives the test cartridge 100 and mounts the test cartridge 100 in a secured position on the cartridge holder 704. The test system 700 then moves the fluid connector 502 towards the body 102 of the test cartridge 100, such that each of the hypodermic needles 508 pierces the membrane 130 of the test cartridge 100 and fluidly couples a respective needle tube 510 to one of the diluent inlet 110, reagent inlet 112, or air outlet 116 of the fluid path 104. The cartridge holder 704 supports the test cartridge 100 in a vertical position, such that the fluid path 104 (for example, the front surface 106 of the body 102 that supports the fluid path 104) extends in a substantially vertical direction.

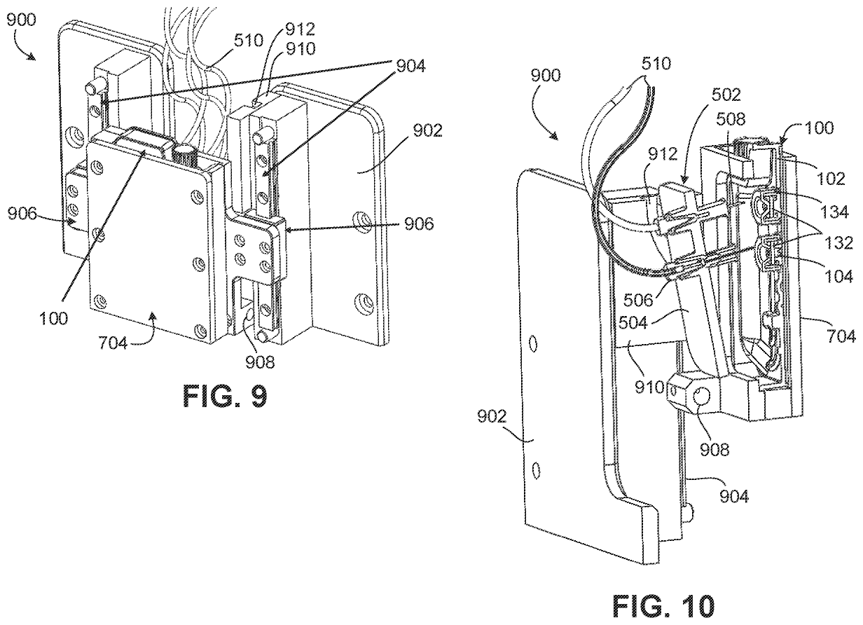

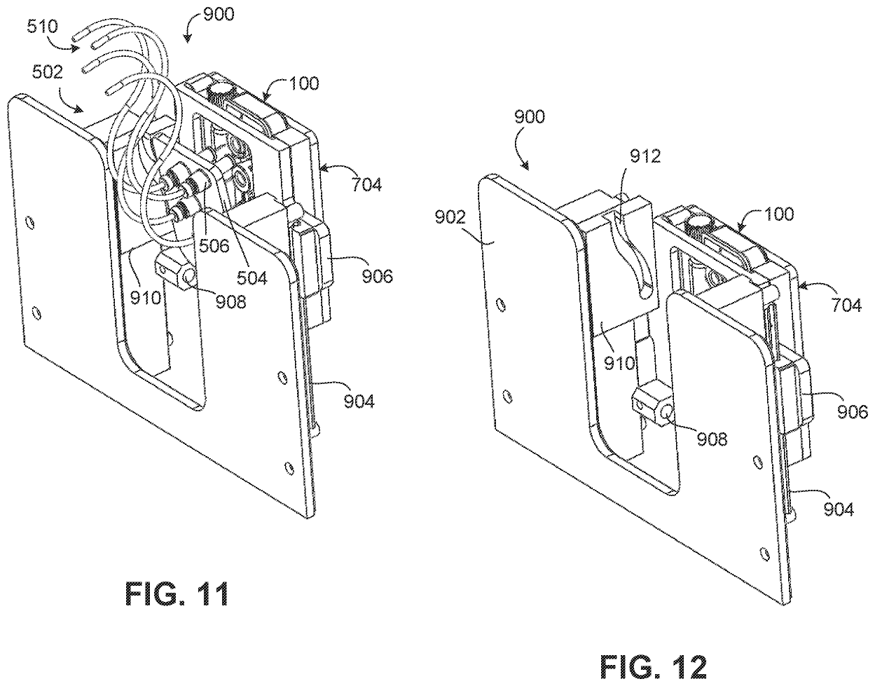

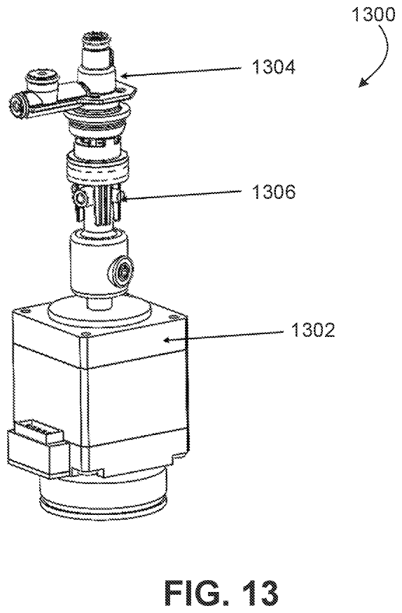

FIG. 9 is a partial perspective front view of an engagement assembly 900 of the example test system 700 of FIG. 7, which includes the cartridge holder 704, the test cartridge 100, and the fluid connector 502. FIGS. 10, 11, and 12 are a cross-sectional, partial perspective back view, a partial perspective back view, and another partial perspective back view, respectively, of the engagement assembly 900 of the example test system 700 of FIG. 9. FIGS. 9-12 show various closer views of the engagement assembly 900 showing details of the engagement between the fluid connector 502, test cartridge 100, and the structure of the test system 700 that positions the fluid connector into engagement with the test cartridge 100 with consistency and accuracy.

Referring to FIGS. 9-12, the engagement assembly 900 includes a frame plate 902 supporting a set of vertical rails 904 extending vertically on either side of the cartridge holder 704. The cartridge holder 704 includes carriages 906 on lateral sides of the cartridge holder 704 that correspond to and engage with the set of vertical rails 904 on the frame plate 902. The carriages 906 are slidably connected to the set of rails 904, for example, to allow the cartridge holder 704 to slide along the rails 904 between a first, raised position and a second, lowered position of the cartridge holder 704.

In some implementations, the carrier plate 504 of the fluid connector 502 connects to the cartridge holder 704 with a pivot connection 908. The pivot connection 908 can rotatably engage a portion of the carrier plate 504 such that the carrier plate 504 pivotally couples to the cartridge holder 704 and moves with the cartridge holder 704 between the first, raised position and the second, lowered position. In some embodiments, the carrier plate 504 includes lateral pins at an end of the carrier plate 504 that extend to and engage the pivot connection 908 (e.g., pin slot).

The engagement assembly 900 also includes a guide plate 910 connected to the frame plate 902 that guides a movement of the carrier plate 504 of the fluid connector as both the test cartridge 100 and fluid connector 502 are lowered along the cartridge holder 704. In some examples, the guide plate 910 includes a cam track 912 that corresponds with a pin, cam, or other structure on the carrier plate 504 to guide a movement of the guide plate 910 relative to the test cartridge 100.

During a testing operation, the test cartridge 100 is mounted on the cartridge holder 704 and suspended in the first raised position. The cartridge holder 704 in combination with the guide plate 910 holds the carrier plate 504 of the fluid connector 502 away from the test cartridge 100. As the cartridge holder 704 is lowered toward the second, lowered position, the cam track 912 on the guide plate 910 moves the carrier plate 504 to pivot about the pivot connection 908 and relative to the test cartridge 100 to move the fluid connector 502 toward the body 102 of the test cartridge 100. At the second, lowered position of the cartridge holder 704, the fluid connector 502 is engaged with the test cartridge 100 such that the hypodermic needles 508 of the fluid connector 502 are engaged with corresponding inlets and/or outlets of the test cartridge 100. After this engagement, a testing operation can comments and fluids can be pumped into the fluid path 104, air can be pumped or vented out of the fluid path 104, or both. After a testing operation concludes, the cartridge holder 704 can be raised to the first, raised position, thereby causing the carrier plate 504 of the fluid connector 502 to pivot away from the test cartridge 100 and out of engagement with the test cartridge 100, for example, to allow the test cartridge 100 to be disposed and replaced with a second, different test cartridge. The second test cartridge can then bet positioned within the same cartridge holder 704, and a subsequent testing operation can commence within the test system 700, but with the second test cartridge. The example test system 700 provides for easily repeatable testing operations using disposable test cartridges with lesser or nonexistent risk of contamination between testing operations.

FIG. 13 is a perspective view of an example pump drive 1300. The pump drive 1300 can be used in the pump drive 708 of the example test system 700 of FIGS. 7 and 8. The pump drive 1300 includes a 5-phase stepper motor 1302, for example, to drive one of the pumps 706 of the example test system 700. The pump drive 1300 includes the 5-phase stepper motor 1302, a micropump 1304, and a coupling 1306 between the 5-phase stepper motor 1302 and the micropump 1304. In some instances, the micropump 1304 can replace or work in series with one if the pumps 706 of the test system 700.

The 5-phase stepper motor 1302 reduces a vibration during operation of the pump drive 1300, for example, as compared to 2-phase stepper motors or direct current (DC) motors with gearboxes. The 5-phase stepper motor 1302 also reduces a cost of providing a motor drive for micropumping applications. Some conventional 2-phase stepper motors produce vibration as the phases are energised in turn to attract the rotor. 2-phase motors can be driven in half-steps (e.g., 200 steps per revolution) to reduce vibration, but still causes levels of vibration that are unacceptable for micropump applications. It is possible to drive the stepper motor in half steps or microsteps to reduce vibration, but the level of vibration has been considered to be unacceptable to drive a micropump. The 5-phase stepper motor 1302 includes 10 poles (2 per phase) and has 500 steps per revolution. Due to the smaller step angles, the vibration generated by the 5-phase stepper motor 1302 is much less than in a 2-phase stepper motor.

A number of implementations have been described. Nevertheless, it will be understood that various modifications may be made without departing from the spirit and scope of the disclosure.

1. A test cartridge comprising:
a body that defines a fluid path comprising a specimen inlet, a diluent inlet, a reagent inlet, a reaction chamber, and an air outlet;
a cover configured to cooperate with the body to seal the fluid path, wherein the cover is transparent in the region of the reaction chamber; and
a membrane coupled to the body and configured to seal the diluent inlet, the reagent inlet, and the air outlet.

2. The test cartridge according to claim 1, wherein the membrane comprises a plurality of discrete membrane portions, wherein each membrane portion is configured to seal one of the diluent inlet, the reagent inlet, or the air outlet.

3. The test cartridge according to claim 2, further comprising a plurality of membrane clamps, wherein each membrane clamp is configured to clamp a respective membrane portion to the body.

4. The test cartridge according to claim 1, wherein the body has one or more surfaces, and wherein the diluent inlet, the reagent inlet, and the air outlet are arranged on the same surface of the one or more surfaces of the body.

5. The test cartridge according to claim 1, wherein the body further defines a threaded connection adjacent to the specimen inlet.

6. The test cartridge according to claim 1, further comprising a protective film configured to seal the specimen inlet.

7. The test cartridge according to claim 1, wherein the reaction chamber is a first reaction chamber, and wherein the fluid path comprises a second reaction chamber in serial arrangement relative to the first reaction chamber.

8. The test cartridge according to claim 1, wherein the cover is transparent in the region of the specimen inlet, the diluent inlet, the reagent inlet, the one or more reaction chambers, and the air outlet.

9. The test cartridge according to claim 1, wherein the body is monolithic.

10. The test cartridge according claim 1, wherein the fluid path further comprises a wash chamber.

11. A test assembly comprising:
the test cartridge according to claims; and
a fluid connector comprising:
a carrier plate that defines a plurality of openings, wherein each opening is configured for alignment with one of the diluent inlet, the reagent inlet, or the air outlet,
a plurality of hypodermic needles, wherein each hypodermic needle is arranged at a corresponding opening of the carrier plate,
a plurality of needle tubes, wherein each needle tube is coupled to the hypodermic needle.

12. The test assembly according to claim 11, further comprising a plurality of pumps, each pump having a pump inlet and a pump outlet, wherein each pump outlet is configured for connection to one of the plurality of needle tubes.

13. The test assembly according to claim 12, further comprising, for each of the plurality of pumps, a container that comprises a container wall defining an interior space configured to receive a liquid, wherein each pump is connected to the container wall with the pump inlet in direct communication with the interior space of the container.

14. A test system comprising:
a test assembly according to claim 12;
a plurality of pump drives, wherein each pump drive is configured to drive a respective one of the plurality of pumps; and
a cartridge holder configured to receive the test cartridge;
wherein the test system is configured to move the fluid connector towards the body of the test cartridge, such that each of the plurality of hypodermic needles pierces the membrane of the test cartridge and fluidly couples a respective needle tube to one of the diluent inlet, the reagent inlet, or the air outlet.

15. The test system of claim 14, wherein the cartridge holder is configured to support the test cartridge such that the fluid path extends in a substantially vertical direction.

16. The test system of claim 14, further configured to pivot the carrier plate relative to the test cartridge to move the fluid connector towards the body of the test cartridge.

17. The test system of any one of claim 14, wherein each of the plurality of pump drives comprises a 5-phase stepper motor configured to drive a respective one of the pumps.
